(19) United States
(12) Patent Application Publication
(10) Pub. No.: US 2021/0084847 A1
(43) Pub. Date: Mar. 25, 2021

(54) PORTABLE INVERSE FLOW HYDROPONIC SYSTEM

(71) Applicants: John Kainer, Christmas, FL (US); David Gidddens, Orlando, FL (US)

(72) Inventors: John Kainer, Christmas, FL (US); David Gidddens, Orlando, FL (US)

(21) Appl. No.: 16/582,634

(22) Filed: Sep. 25, 2019

(51) Int. Cl. A01G 31/02

(52) U.S. Cl. CPC A01G 31/02; A01G 2031/006

(57) ABSTRACT

A portable hydroponic system includes a water tank and a media pot having a plurality of apertures that is removably positioned along the top of the tank. A lower housing and an upper housing are removably positioned within the tank beneath the media pot. Each of the housings including a central opening that are vertically aligned and a supply line is positioned through the openings. A submersible water pump is positioned within the lower housing and is connected to the supply line. An air pump having an air supply hose is also connected to the supply line. The pumps supply highly oxygenated water through the inside of the upper housing to the apertures along the bottom of the media pot and pull water from the apertures along the sides of the pot downward along the outside of the upper and lower housings back into the pump.

### TECHNICAL FIELD

The present invention relates generally to hydroponics, and more particularly to an improved hydroponic system that is portable and utilizes an inverse water flow pattern.

### BACKGROUND

The statements in this section merely provide background information related to the present disclosure and may not constitute prior art.

In recent years, the use of hydroponic systems has increased drastically, as such systems allow individuals to raise their crops without any agricultural pesticides, and in a manner that avoids several types of plant diseases that affect traditional soil farming.

Traditional hydroponic systems utilize a large hydroponic tank that is installed within a greenhouse or other fixed location. The tank is filled with water and/or a nutrient solution, and further includes at least one crop carrier that floats within the tank on the nutrient solution in the hydroponic tank. The carrier has a plurality of vertical holes attached with a perforated dish that holds a seedling. As the seedling grows, its roots extend along the vertical holes to absorb water and nutrients from the solution.

In most instances, the solution remains within the tank, thus requiring the user to constantly monitor the water levels to ensure proper PH balance and other nutrient levels. Unfortunately, when the levels are not maintained properly, the water becomes stagnant and leads to root-rot. To combat this situation, there are known flood fill-type systems that pump water from the tank through a filter and return the filtered water to the tank. While beneficial in preventing the water from becoming stagnant, such systems require complex plumbing and expensive filters that must be changed and replaced regularly. As a result, such systems are not easily moved or transported, thus making their use by individuals seeking to grow non-commercial crops unappealing and cost prohibitive.

Accordingly, it would be beneficial to provide an improved hydroponic system that removes the need for external plumbing and filters, while providing advanced nutrient circulation within the tank. It would also be beneficial to provide such a system in a compact size that can be easily transported and operated by anyone.

### SUMMARY OF THE INVENTION

The present invention is directed to a portable hydroponic system. One embodiment of the present invention can include a water tank having a closed bottom end, a side wall, an open top end and an interior space. A media pot having a plurality of apertures can be removably positioned along the top of the tank. A lower housing and an upper housing can be removably connected together and can be positioned within the tank such that openings along the center of each housing are aligned vertically. A supply line can be positioned through the openings and can extend from the bottom housing through to the upper housing.

In one embodiment, a submersible water pump can be positioned within the lower housing and can be connected to the supply line. Additionally, an air pump can be positioned along the exterior of the tank and can include an air supply hose that is connected to the supply line.

The pumps can function to supply highly oxygenated water through the inside of the upper housing to the apertures along the bottom of the media pot, and the pump draws cascading water through apertures in the lower housing back into the pump.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is an exploded parts view of a portable inverse flow hydroponic system that is useful for understanding the inventive concepts disclosed herein.

FIG. 2A is a top perspective view of the upper housing of the portable inverse flow hydroponic system, in accordance with one embodiment of the invention.

FIG. 2B is a bottom perspective view of the upper housing of the portable inverse flow hydroponic system, in accordance with one embodiment of the invention.

FIG. 3A is a top perspective view of the lower housing of the portable inverse flow hydroponic system, in accordance with one embodiment of the invention.

FIG. 3B is a bottom perspective view of the lower housing of the portable inverse flow hydroponic system, in accordance with one embodiment of the invention.

FIG. 4 is a cross sectional view of the portable inverse flow hydroponic system, in accordance with one embodiment of the invention.

FIG. 5 is a cross sectional view of the portable inverse flow hydroponic system in operation, in accordance with one embodiment of the invention.

FIG. 6 is a perspective view of the portable inverse flow hydroponic system in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As described herein, the term “portable” means that the entire fully assembled self-contained hydroponic system 10 can be of such a size and weight that it can be carried and transported by an average adult without the aid of specialized equipment. In one nonlimiting embodiment, the size is less than 2 feet in height, less than 1 foot in diameter and weighing less than 50 pounds when full of water.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

As described herein, the term “removably secured” and derivatives thereof shall be used to describe a situation wherein two or more objects are joined together in a non-permanent manner so as to allow the same objects to be repeatedly joined and separated. This can be accomplished through the use of any number of commercially available connectors such as opposing strips of hook and loop material (i.e. Velcro®), magnets, and/or compression fittings such as locking pins, male and female fittings, clamps, tethers (e.g., zip ties), snaps and buttons, for example.

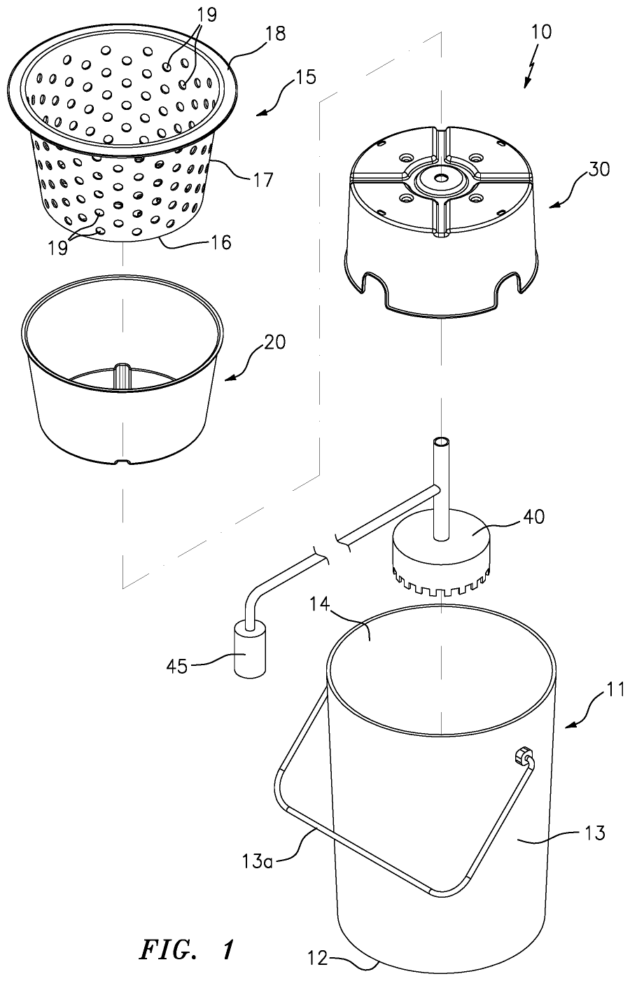

FIGS. 1-6 illustrate various embodiments of a portable inverse flow hydroponic system 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

FIG. 1 is an exploded parts view of the system components, in accordance with one embodiment. As shown, the system 10 can include a tank 11, a media pot 15, an upper housing 20, a lower housing 30, a submersible pump 40, and an air pump 45.

The tank 11 can function to receive and submerge each of the system components 15-40 in a fluid such as water or other nutrient solutions. In one embodiment, the tank 11 can include a generally cylindrical shaped body having a closed bottom end 12, a continuous side wall 13 having an optional carrying handle 13a, and an open top end 14. The tank will preferably be constructed from a lightweight material such as UV resistant heavy-duty PVC plastic, for example, and may comprise or consist of a commercially available five gallon bucket; however, other shapes, sizes and construction materials are also contemplated.

The media pot 15 can include a body section that is defined by a bottom end 16, a continuous side wall 17, an open top end 18, and a plurality of apertures 19 that are arranged along the bottom and side walls. The pot may be constructed from the same material as the tank 11, or any number of other materials that are suitable for prolonged exposure to moisture.

As will be described below, the media pot 15 is designed to be secured along the top end 14 of the tank 11 so as to allow a portion of the media pot body to be submerged in a fluid. To this end, the top end of the pot 18 can include a diameter/dimension that is complementary to the diameter/dimension of the top end 14 of the tank, and the bottom and side walls of the pot 15 can include a dimension/diameter that is less than the open top end of the tank 11.

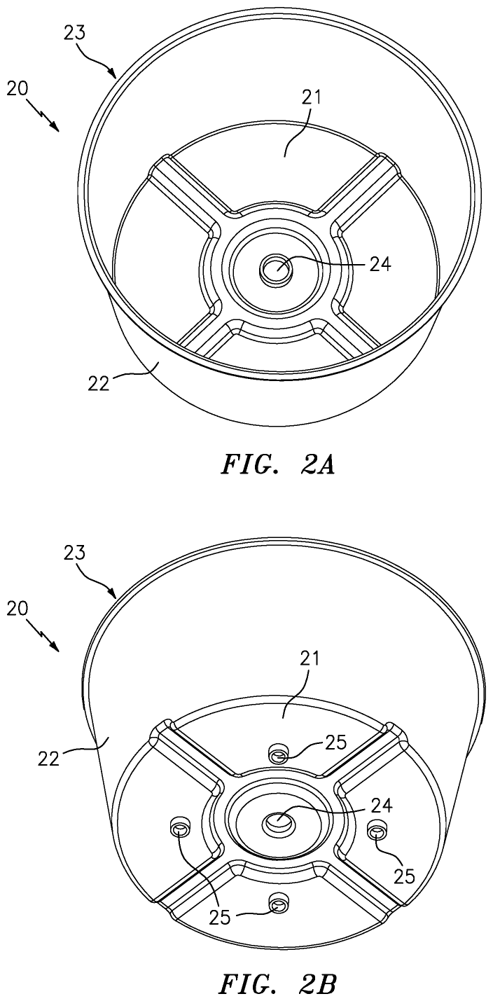

FIGS. 2A and 2B illustrate one embodiment of the upper housing 20. As shown, the upper housing 20 can include a body section that is defined by a closed bottom end 21, a continuous side wall 22, an open top end 23, and an opening 24 that is disposed through the bottom end. In one embodiment, a plurality of cylindrical-shaped protrusions 25 can extend downward from the bottom end 21.

As the upper housing is designed to be positioned within the tank 11, the housing 20 will include an outer dimension/diameter that is less than the inner dimension/diameter of the tank 11. In the preferred embodiment, the upper housing 20 can be constructed from high density plastic so as to be non-buoyant, thereby enabling the upper housing to remain submerged within the fluid contained within the tank 11. Of course, any number of other shapes, sizes and construction materials are also contemplated.

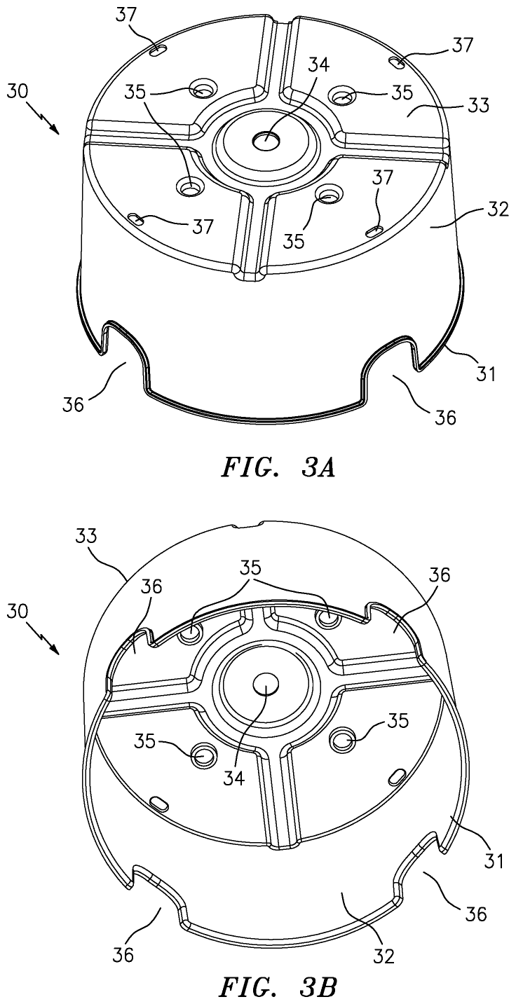

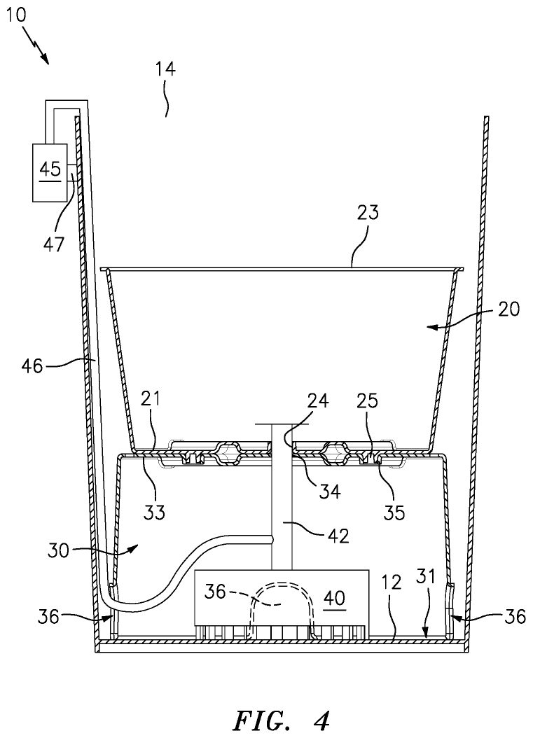

FIGS. 3A and 3B illustrate one embodiment of the lower housing 30. As shown, the lower housing can include a body section that is defined by an open bottom end 31, a continuous side wall 32, a closed top end 33, and an opening 34 that is disposed through the closed top end. In one embodiment, a plurality of cylindrical-shaped channels 35 can be positioned along the closed top end at locations complementary to the above described protrusions 25. The protrusions and channels functioning to removably secure the upper and lower housings together, as shown at FIG. 4. Additionally, a plurality of semi-circular shaped apertures 36 can be disposed along the periphery of the open bottom end 31.

The lower housing is also designed to be positioned within the tank 11 and will therefore include an outer dimension/diameter that is less than the inner dimension/diameter of the tank 11. Likewise, the lower housing 30 will preferably be constructed from the same material as the upper housing 20 so as to be non-buoyant. Of course, any number of other shapes, sizes and construction materials are also contemplated.

In one embodiment, a plurality of venting apertures 37 can be disposed along the top end the lower housing. These apertures 37 functioning to mitigate buoyance of the housing 30 by allowing captured air to be displaced by the fluid contained within the tank.

As shown in FIG. 4, the top end of the lower housing 33 can be secured to the bottom end of the upper housing 21 via the connectors 25/35. When so positioned, the central openings 24 and 34 will be aligned, and the assembly can be positioned within the tank 11 so that the open bottom end 31 is resting on the bottom 12 of the tank.

In one embodiment, a submersible water pump 40 can be positioned along the bottom end 12 of the tank so as to be located within the lower housing 30. The output of the pump can be connected to a supply line 42 such as a PVC pipe, for example that passes through the openings 24/34 to terminate within the upper housing 20.

As described herein, the submersible pump 40 can include any number of devices capable of circulating fluids throughout the system 10 in the manner described herein. One example of a suitable submersible water pump 40 includes the 300 GPH submersible water pump that is commercially available from Ankway Inc. However, any number of other water pumping devices are also contemplated. Although not specifically illustrated, the pump may include a power cable which can be routed adjacent to the below described air hose 46 during system operation.

In one embodiment, the system 10 can also include an air pump 45 having an air hose 46 that is connected to the supply line 42. As shown, the air pump 45 can be removably secured along the outside of the tank 11 via a connector 47 such as hook and loop material, for example, and the supply line can be routed through one of the semi-circular apertures 36.

As described herein, any number of different devices capable of pushing air through the supply line in the manner described herein. One example of a suitable air pump 45 includes the Vivisun air pump 9 that is commercially available from JW Pet Company, for example. However, any number of other types of air pumping devices are also contemplated.

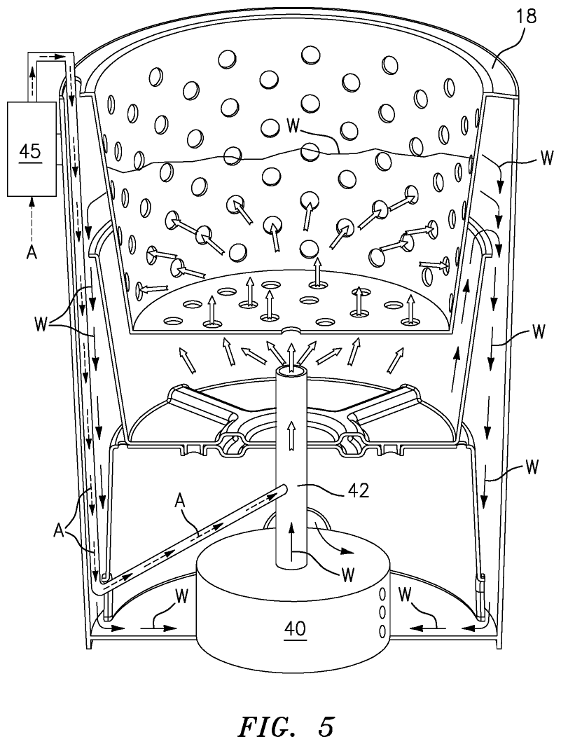

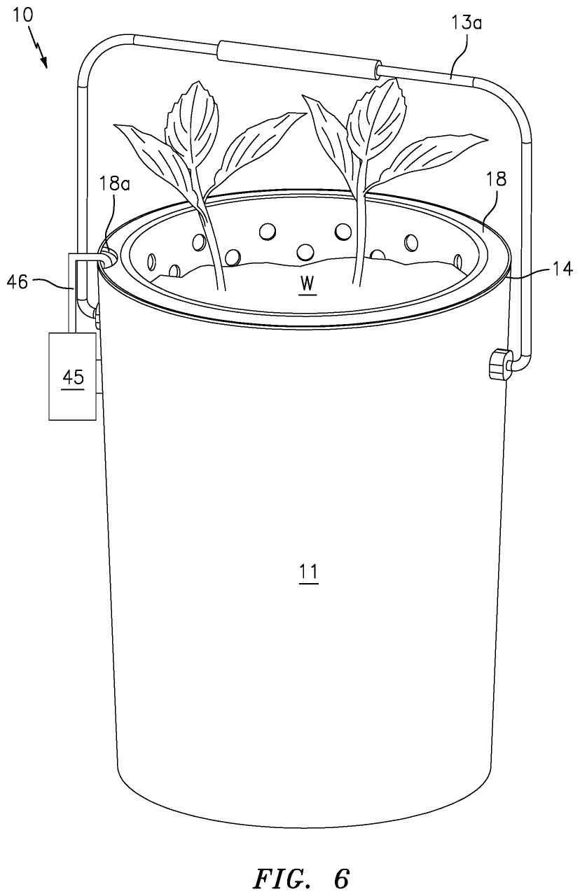

FIGS. 5 and 6 illustrate one embodiment of the system 10 in operation. As shown, the tank 11 can be filled with water W or other nutrient solutions, and the media pot 15 can be positioned within the tank 11 wherein the ledge along the top end 18 is resting on the top end 14 of the tank. In various embodiments, an indentation 18a is located along the top of the media pot to allow passage of the air supply hose 46 and/or the power cord for the submersible pump. When so positioned, the bottom end 16 of the pot 15 will be located within the upper housing 20 and will be positioned directly above the distal end of the supply line 42.

Next, the water pump 40 and the air pump 45 can be activated. In operation, the submersible pump 40 will push water W up through the supply line 42, and the air pump 45 will push fresh air A through the air hose 46. The air A and water W will merge inside the supply line 42, thus resulting in a water/oxygen mixture M comprising highly oxygenated water that will emanate from the distal end of the supply line 42. This mixture will flow upward (inversely to traditional systems) through the inside of the upper housing 20 and directly into the apertures 19 on the bottom of the media pot 15 where it can be absorbed by crops 1 that are located within the pot.

Owing to the constant sucking force imparted by the submerged pump 40, the resulting water W will then flow out of the apertures 19 along the sides of the pot and be sucked/cascade down along the outside of the upper housing 20 and the lower housing 30 and through the semicircular openings 36 located on the bottom of the lower housing, where it will be fed back into the pump 40, thus restarting the cycle. In this manner, the water flowing within the upper and lower housings will have an upward movement, and the water flowing along the outside of the upper and lower housings adjacent to the sidewall of the tank 11 will have a downward movement i.e., inverse circulation.

By positioning the top end of the media pot 18 flush with the top end of the tank 14, the handle 13a can swing upward above the components so as to not interfere with the operation of the device or the growth of the crops 1. Additionally, when using a battery powered submersible pump 40 and battery powered air pump 45, the system can be easily carried via the handle while continuing to operate, thus making the system portable during operation.

Accordingly, the above described system provides an innovative portable hydroponic system that utilizes inverse flow to essentially force feed highly oxygenated water and/or nutrient solutions to any number of different types of crops, without requiring the highly complex pumping and support equipment of prior art devices.

As described herein, one or more elements of the system 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A portable hydroponic system, comprising:
a tank having a closed bottom end, a side wall, an open top end and an interior space;
a lower housing having an open bottom end, a side wall, and a closed top end; and
an upper housing having a closed bottom end, a side wall and an open top end;
wherein the tank is configured to receive and hold a fluid, and wherein the upper housing is removably connected to the lower housing, and each of the upper housing and the lower housing are removably positioned within the interior space of the tank.

2. The system of claim 1, wherein the tank is constructed from UV resistant plastic, includes a cylindrical shape, and is configured to receive and hold five gallons of the fluid.

3. The system of claim 1, wherein the upper housing and the lower housing are each constructed from a dense non-buoyant material.

4. The system of claim 1, wherein the closed top end of the lower housing is removably connected to the closed bottom end of the upper housing.

5. The system of claim 1, further comprising:
a media pot having a closed bottom end, a side wall, an open top end; and
a plurality of apertures that are disposed along one or both of the closed bottom end and the side wall of the media pot,
wherein the top end of the media pot includes a dimension that is complementary to the dimension of the open top end of the tank, and the bottom end and side wall of the media pot is removably positioned within the interior space of the tank.

6. The system of claim 1, further comprising:
a submersible water pump that is positioned within the lower housing, said water pump being configured to recirculate the fluid located within the tank.

7. The system of claim 1, further comprising:
an air supply line having a first end that is positioned within the tank and a second end that is positioned outside the tank; and
an air pump that is in communication with the second end of the air supply line.

8. The system of claim 7, wherein the air pump is removably connected to the side wall of the tank.

9. The system of claim 1, further comprising:
a carrying handle that is located along the side wall of the tank.
